(19) United States
(12) Patent Application Publication
(10) Pub. No.: US 2013/0034986 A1
(43) Pub. Date: Feb. 7, 2013

(54) ELECTRONIC DEVICE AND METHOD FOR ATTACHING AND DETACHING A CONNECTOR THEREOF

(71) Applicant: Xiu-Feng Cheng, New Taipei City (TW)

(72) Inventor: Xiu-Feng Cheng, New Taipei City (TW)

(73) Assignee: WISTRON CORP., New Taipei City (TW)

(21) Appl. No.: 13/485,630

(22) Filed: May 31, 2012

(30) Foreign Application Priority Data
Aug. 1, 2011 (CN) CN201120275691.8

(51) Int. Cl. H01R 13/62; H01R 43/18

(52) U.S. Cl. 439/372; 29/876

(57) ABSTRACT

An electronic device is provided. The electronic device includes a connection unit and a connector. The connection unit includes at least one port. The connector includes a connector body and at least one connection element. The connection element is disposed on the connector body and is detachably connected to the port, wherein the connection element is rotated between a first orientation and a second orientation, the connection element is fixed to the port when the connection element is in the second orientation, and the connection element is separated from the port when the connection element is in the first orientation.

### CROSS REFERENCE TO RELATED APPLICATIONS

This Application claims priority of China Patent Application No. 201120275691.8, filed on Aug. 1, 2011, the entirety of which is incorporated by reference herein.

### BACKGROUND OF THE INVENTION

1. Field of the Invention

The present invention relates to a connector utilized in electronic devices, and in particular relates to a connector which can be easily attached and detached.

2. Description of the Related Art

A conventional video graphics array connector is fixed to an electronic device via screws. However, with reference to FIG. 1, when the conventional connector 10 is attached to an electronic device (display) 1, screw holding portions 11 of the connector 10 are nestled up against an outer surface 2 of the electronic device 1. When a user want to detach the connector 10 from the electronic device 1 or to attach the connector 10 to the electronic device 1, the user needs to rotate the screw holding portions 11 with his/her fingers. However, the fingers of a user interfere with the outer surface 2 during the rotation motion, such that during each rotation motion, the screw holding portion 11 is rotated only 20-30 degrees. Therefore, conventionally, it is difficult to detach the connector 10 from the electronic device 1 or to attach the connector 10 to the electronic device 1.

### BRIEF SUMMARY OF THE INVENTION

An electronic device is provided. The electronic device includes a connection unit and a connector. The connection unit includes at least one port. The connector includes a connector body and at least one connection element. The connection element is disposed on the connector body and is detachably connected to the port, wherein the connection element is rotated between a first orientation and a second orientation, the connection element is fixed to the port when the connection element is in the second orientation, and the connection element is separated from the port when the connection element is in the first orientation.

Utilizing the embodiments of the invention, the connector is conveniently attached to the connection unit because the connection element abuts the port. Additionally, the connector is conveniently detached from the connection unit by rotating the connection element to the first orientation, wherein the elastic element pushes the connection element to self-separate from the port. In the embodiments of the invention, the connection element is attached to or detached from the port by being rotated in a rotation angle smaller than 360 degrees. For example, in the first embodiment, the rotation angle is about 180 degrees. Compared to conventional fixing designs (by screw), the invention provides improved fixing means which is faster and more convenient.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional video graphics array connector fixed on an electronic device;

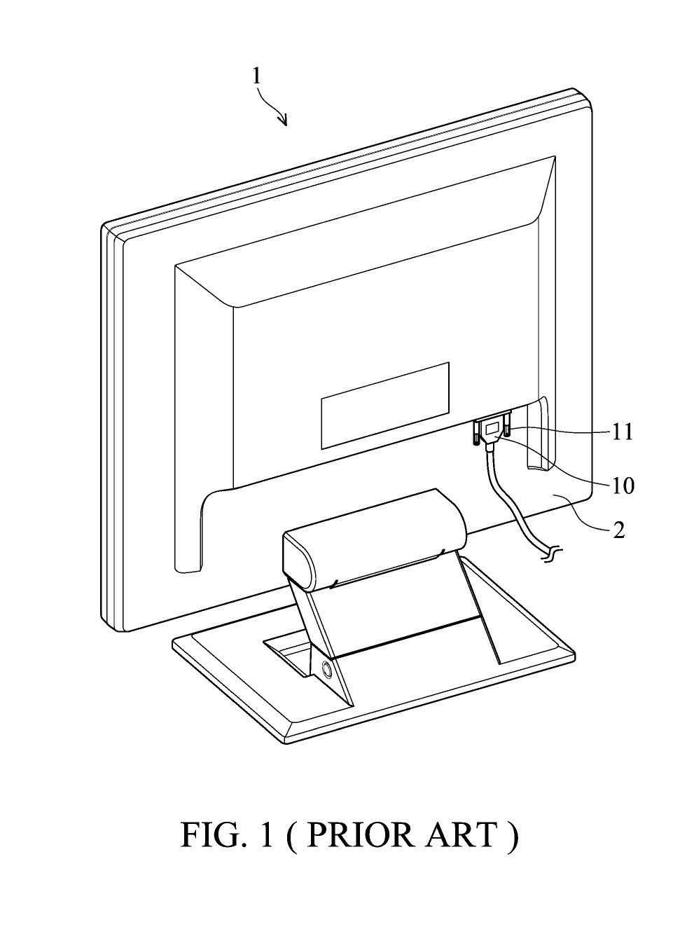

FIG. 2A is a pictorial drawing showing a connector and an electronic device of a first embodiment of the invention, wherein the connector is detached from the electronic device;

FIG. 2B is a top view showing the connector and the electronic device of the first embodiment of the invention, wherein the connector is detached from the electronic device;

FIG. 3A is a pictorial drawing showing the connector and the electronic device of the first embodiment of the invention, wherein the connector is attached to the electronic device;

FIG. 3B is a top view showing the connector and the electronic device of the first embodiment of the invention, wherein the connector is attached to the electronic device;

FIG. 4 is a front view of a connection unit of the first embodiment of the invention;

FIG. 5A is an enlarged view of portion 5A of FIG. 2B;

FIG. 5B is an enlarged view of portion 5B of FIG. 3B;

FIG. 6 shows end of an connection portion of the first embodiment of the invention;

FIG. 7A is a front view of a connection unit of a second embodiment of the invention;

FIG. 7B shows a connection portion of the second embodiment of the invention;

FIG. 8A is a front view of a connection unit of a third embodiment of the invention;

FIG. 8B shows a connection portion of the third embodiment of the invention; and

FIG. 9 shows a method for attaching and detaching a connector of an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

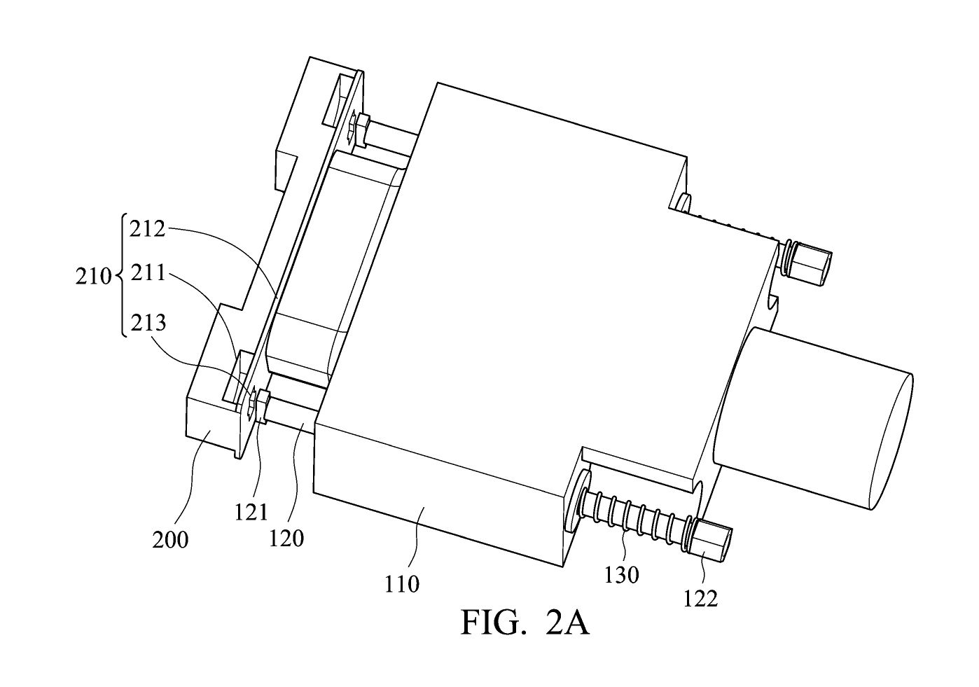

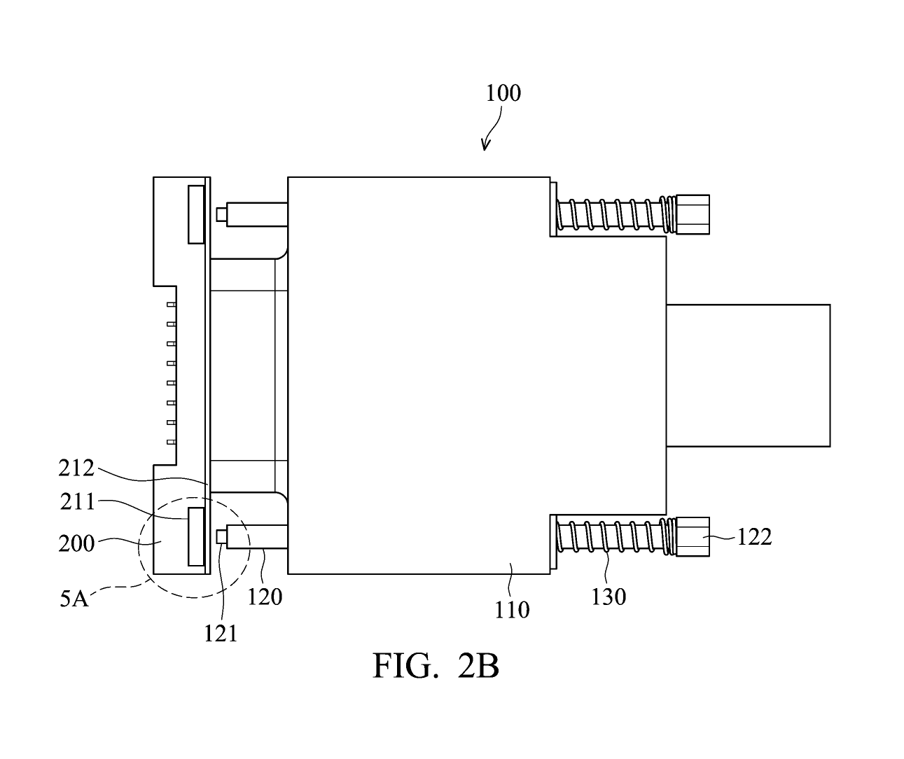

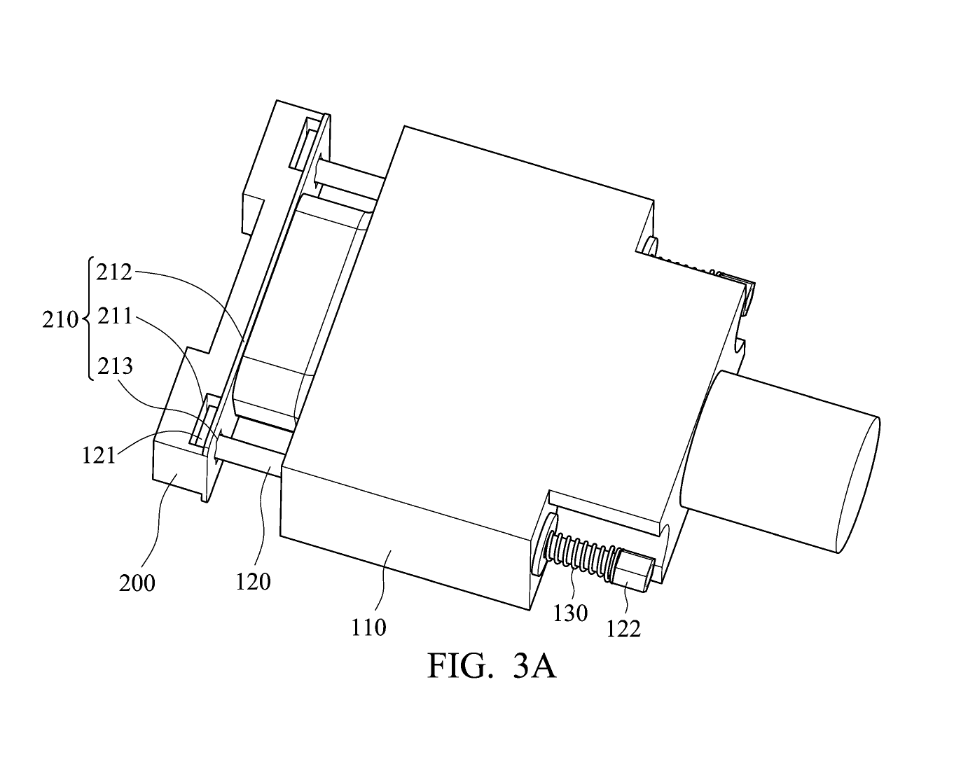

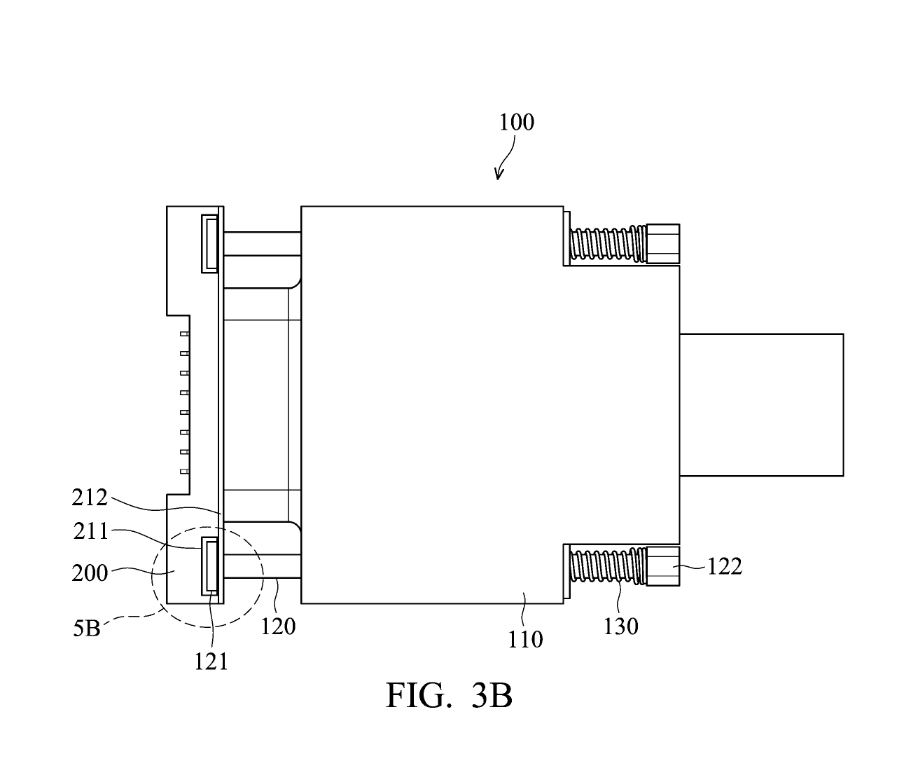

FIG. 2A is a pictorial drawing showing a connector and an electronic device of a first embodiment of the invention, wherein the connector is detached from the electronic device. FIG. 2B is a top view showing the connector and the electronic device of the first embodiment of the invention, wherein the connector is detached from the electronic device. FIG. 3A is a pictorial drawing showing the connector and the electronic device of the first embodiment of the invention, wherein the connector is attached to the electronic device. FIG. 3B is a top view showing the connector and the electronic device of the first embodiment of the invention, wherein the connector is attached to the electronic device. With reference to FIGS. 2A, 2B, 3A and 3B, the connector 100 of the first embodiment of the invention includes a connector body 110, a connection element 120 and an elastic element 130. In the drawings of the embodiments of the invention, the electronic device is omitted, but only a connection unit 200 of the electronic device is shown. The connection unit 200 includes ports 210.

Each of the connection elements 120 comprises a connection portion 121 and a holding portion 122. The connection portion 121 is detachably connected to the port 210. The elastic element 130 is disposed between the holding portion 122 and the connector body 110. When the connection element 120 is separated from the port 210, the elastic element 130 pushes the connection element 120 from a first position (as shown in FIG. 3B) to a second position (as shown in FIG. 2B) by an elastic force thereof.

The connection element 120 is longitudinal, the connection portion 121 and the holding portion 122 are respectively disposed on two ends of the connection element 120. The elastic element 130 is telescoped on the connection element 120.

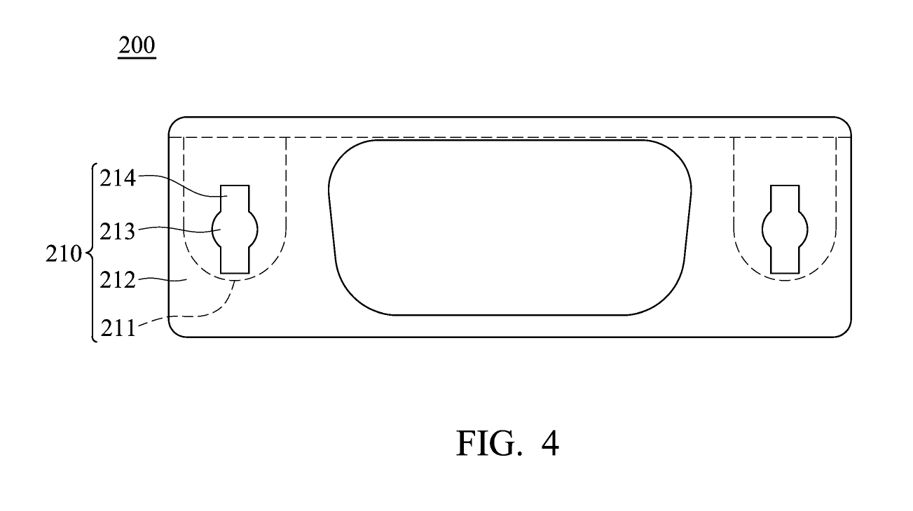

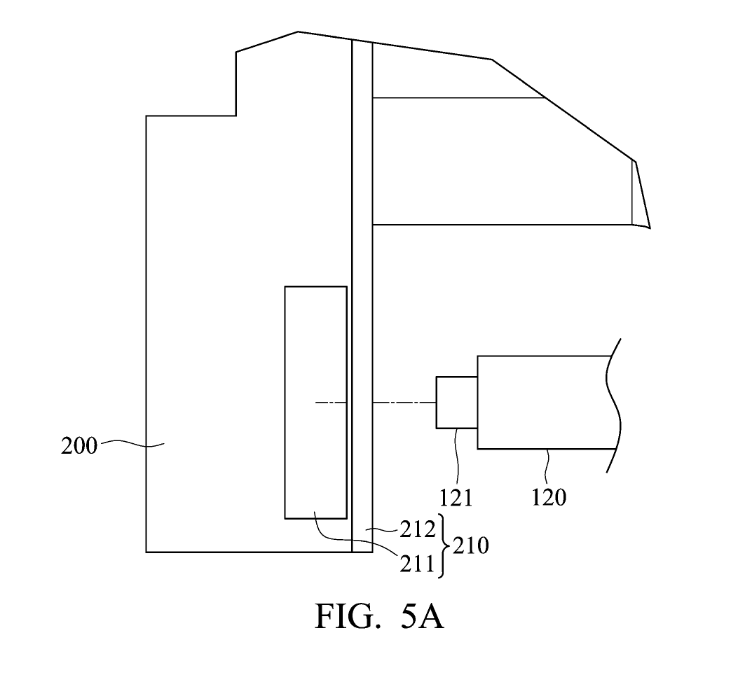

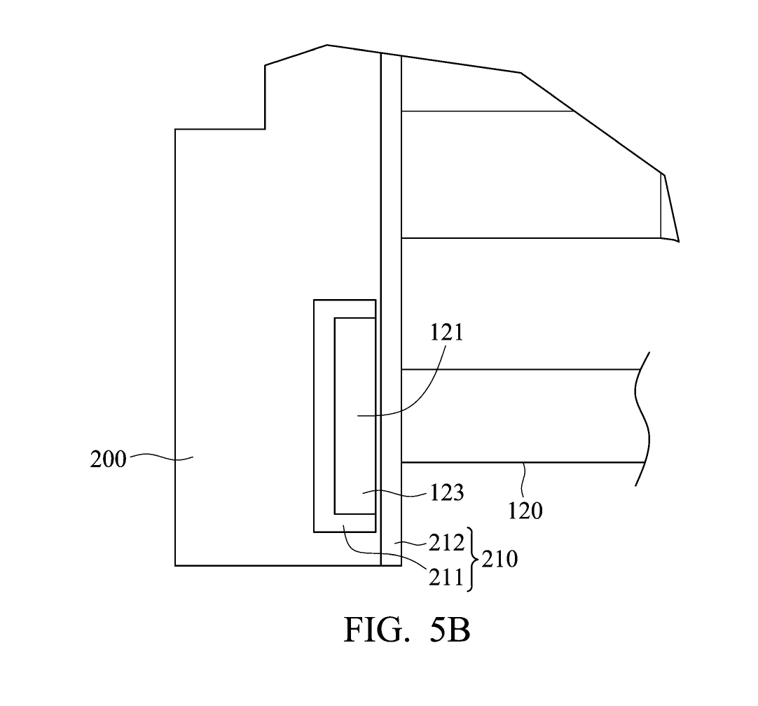

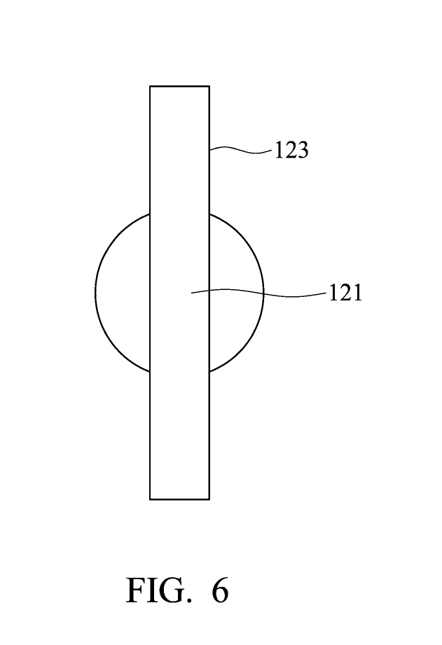

FIG. 4 is a front view of the connection unit 200. FIG. 5A is an enlarged view of portion 5A of FIG. 2B. FIG. 5B is an enlarged view of portion 5B of FIG. 3B. FIG. 6 shows an end of the connection portion 121. With reference to FIGS. 4, 5A and 5B, the port 210 has a slot 211 and a cover 212. The cover 212 covers the slot 211, an opening 213 is formed on the cover 212, and the opening 213 is communicated to the slot 211. In this embodiment, the opening 213 has an I-shaped extending portion 214, the connection portion 121 has an I-shaped protrusion 123 (FIG. 6). The connection element 120 is rotated between a first orientation (as shown in FIG. 5B) and a second orientation (as shown in FIG. 5A). When the connection element is in the second orientation (FIG. 5B), the I-shaped protrusion 123 of the connection portion 121 of the connection element 120 is in the slot 211 and abuts the cover 212. When the connection element 120 is in the first orientation, the I-shaped protrusion 123 of the connection portion 121 passes through the I-shaped extending portion 214 of the opening 123 and is separated from the port 210 (FIG. 5A).

The electronic device of the embodiments of the invention can be a display, a computer or other electronic devices. The connector can be a video graphics array connector.

Utilizing the embodiments of the invention, the connector is conveniently attached to the connection unit by abutting the connection portion in the port. Additionally, the connector is conveniently detached from the connection unit by rotating the connection element to the first orientation, wherein the elastic element pushes the connection element to self-separate from the port. In the embodiments of the invention, the connection element is attached to or detached from the port by being rotated in a rotation angle smaller than 360 degrees. For example, in the first embodiment, the rotation angle is about 180 degrees. Compared to conventional fixing designs (by screw), the invention provides improved fixing means which is faster and more convenient.

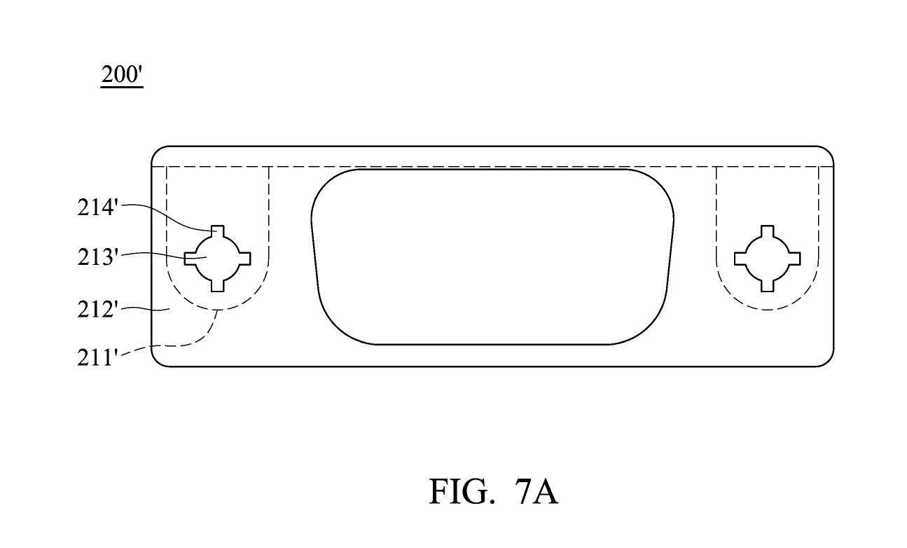

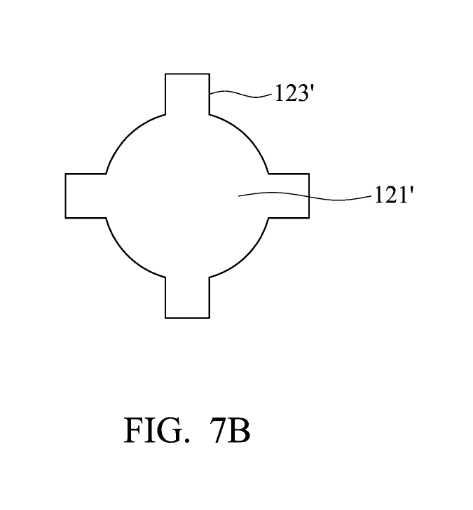

FIG. 7A is a front view of a connection unit 200′ of a second embodiment of the invention. FIG. 7B shows a connection portion 121′ of the second embodiment. In the second embodiment, the opening 213′ has a cross-shaped extending portion 214′, and the connection portion 121′ has a cross-shaped protrusion 123′. When the connection element is in a second orientation, the cross-shaped protrusion 123′ of the connection portion 121′ is in the slot 211′ and abuts the cover 212′ of the port. When the connection element is in a first orientation, the cross-shaped protrusion 123′ of the connection portion 121′ passes through the cross-shaped extending portion 214′ of the opening 213′ and is separated from the port. In the second embodiment of the invention, the connection element is attached to or detached from the port by being rotated in a rotation angle of about 90 degrees.

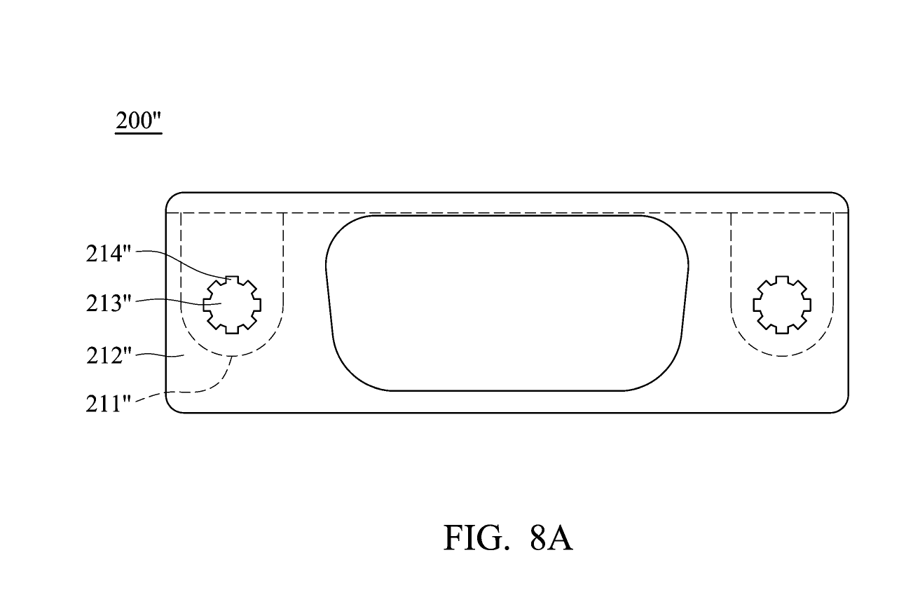

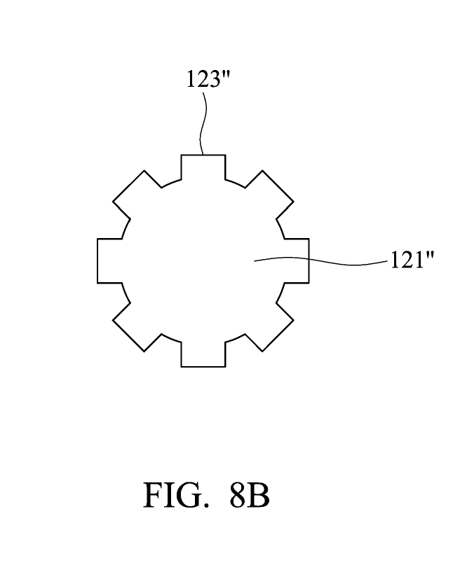

FIG. 8A is a front view of a connection unit 200″ of a third embodiment of the invention. FIG. 8B shows a connection portion 121″ of the third embodiment. In the third embodiment, the opening 213″ has a stellar extending portion 214″, and the connection portion 121″ has a stellar protrusion 123″. When the connection element is in a second orientation, the stellar protrusion 123″ of the connection portion 121″ is in the slot 211″ and abuts the cover 212″ of the port. When the connection element is in a first orientation, the stellar protrusion 123″ of the connection portion 121″ passes through the stellar extending portion 214″ of the opening 213″ and is separated from the port. In the third embodiment of the invention, the connection element is attached to or detached from the port by being rotated in a rotation angle of about 45 degrees.

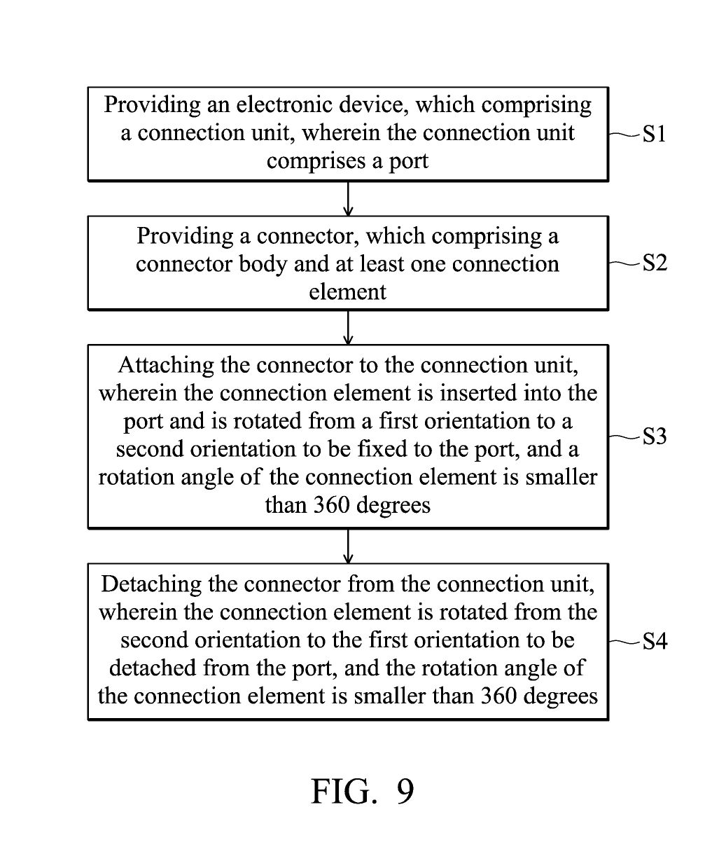

FIG. 9 shows a method for attaching and detaching a connector of an embodiment of the invention, which comprises the following steps. First, an electronic device is provided. The electronic device includes a connection unit, wherein the connection unit comprises a port (S1). Next, a connector is provided. The connector comprises a connector body and at least one connection element (S2). Then, the connector is attached to the connection unit, wherein the connection element is inserted into the port and is rotated from a first orientation to a second orientation to be fixed to the port, and a rotation angle of the connection element is smaller than 360 degrees (S3). Finally, the connector is detached from the connection unit, wherein the connection element is rotated from the second orientation to the first orientation to be detached from the port, and the rotation angle of the connection element is smaller than 360 degrees (S4).

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a connection unit, comprising at least one port; and
a connector, comprising:
a connector body; and
at least one connection element, disposed on the connector body and is detachably connected to the port, wherein the connection element is rotated between a first orientation and a second orientation, the connection element is fixed to the port when the connection element is in the second orientation, and the connection element is separated from the port when the connection element is in the first orientation.

2. The electronic device as claimed in claim 1, wherein the connector further comprises at least one elastic element, the connection element comprises a connection portion and a holding portion, the connection portion is detachably connected to the port, and the elastic element is disposed between the holding portion and the connector body, wherein when the connection element is separated from the port, the elastic element pushes the connection element from a first position to a second position.

3. The electronic device as claimed in claim 2, wherein the connection element is longitudinal, and the connection portion and the holding portion are respectively disposed on two ends of the connection element.

4. The electronic device as claimed in claim 3, wherein the elastic element is telescoped on the connection element.

5. The electronic device as claimed in claim 3, wherein the port has a slot and a cover, the cover covers the slot, an opening is formed on the cover, and the opening is communicated to the slot, wherein when the connection element is in the second orientation, the connection portion is in the slot and abuts the cover, and when the connection element is in the first orientation, the connection portion passes through the opening and is separated from the port.

6. The electronic device as claimed in claim 5, wherein the opening has an I-shaped extending portion, and the connection portion has an I-shaped protrusion, wherein when the connection element is in the second orientation, the I-shaped protrusion of the connection portion abuts the cover of the port, and when the connection element is in the first orientation, the I-shaped protrusion of the connection portion passes through the I-shaped extending portion of the opening and is separated from the port.

7. The electronic device as claimed in claim 5, wherein the opening has a crisscross extending portion, and the connection portion has a crisscross protrusion, wherein when the connection element is in the second orientation, the crisscross protrusion of the connection portion abuts the cover of the port, and when the connection element is in the first orientation, the crisscross protrusion of the connection portion passes through the crisscross extending portion of the opening and is separated from the port.

8. The electronic device as claimed in claim 5, wherein the opening has a stellar extending portion, and the connection portion has a stellar protrusion, wherein when the connection element is in the second orientation, the stellar protrusion of the connection portion abuts the cover of the port, and when the connection element is in the first orientation, the stellar protrusion of the connection portion passes through the stellar extending portion of the opening and is separated from the port.

9. An electronic device, comprising:
a connection unit, comprising at least one port; and
a connector, comprising:
a connector body; and
at least one connection element, comprising a connection portion and a holding portion, wherein the connection element is disposed on the connector body and is detachably connected to the port via the connection portion; and
at least one elastic element, disposed between the holding portion and the connector body, wherein when the connection element is separated from the port, the elastic element pushes the connection element from a first position to a second position.

10. The electronic device as claimed in claim 9, wherein the connection element is longitudinal, the connection portion and the holding portion are respectively disposed on two ends of the connection element, and the elastic element is telescoped on the connection element.

11. A method for attaching and detaching a connector, comprising:
providing an electronic device, which comprises a connection unit, wherein the connection unit comprises a port;
providing a connector, which comprises a connector body and at least one connection element, wherein the connection element is disposed on the connector body;
attaching the connector to the connection unit, wherein the connection element is inserted into the port and is rotated from a first orientation to a second orientation to be fixed to the port, and a rotation angle of the connection element is smaller than 360 degrees; and
detaching the connector from the connection unit, wherein the connection element is rotated from the second orientation to the first orientation to be detached from the port, and the rotation angle of the connection element is smaller than 360 degrees.

12. The method as claimed in claim 11, wherein the connector further comprises at least one elastic element, the connection element comprises a connection portion and a holding portion, the connection portion is connected to the port, and the elastic element is disposed between the holding portion and the connector body, wherein when the connection element is separated from the port, the elastic element pushes from a first position to a second position.

13. The method as claimed in claim 12, wherein the connection element is longitudinal, and the connection portion and the holding portion are respectively disposed on two ends of the connection element.

14. The method as claimed in claim 13, wherein the elastic element is telescoped on the connection element.

15. The method as claimed in claim 13, wherein the port has a slot and a cover, the cover covers the slot, an opening is formed on the cover, and the opening is communicated to the slot, wherein when the connection element is in the second orientation, the connection portion is in the slot and abuts the cover, and when the connection element is in the first orientation, the connection portion passes through the opening and is separated from the port.

16. The method as claimed in claim 15, wherein the opening has an I-shaped extending portion, and the connection portion has an I-shaped protrusion, wherein when the connection element is in the second orientation, the I-shaped protrusion of the connection portion abuts the cover of the port, and when the connection element is in the first orientation, the I-shaped protrusion of the connection portion passes through the I-shaped extending portion of the opening and is separated from the port.

17. The method as claimed in claim 15, wherein the opening has a crisscross extending portion, and the connection portion has a crisscross protrusion, wherein when the connection element is in the second orientation, the crisscross protrusion of the connection portion abuts the cover of the port, and when the connection element is in the first orientation, the crisscross protrusion of the connection portion passes through the crisscross extending portion of the opening and is separated from the port.

18. The method as claimed in claim 15, wherein the opening has a stellar extending portion, and the connection portion has a stellar protrusion, wherein when the connection element is in the second orientation, the stellar protrusion of the connection portion abuts the cover of the port, and when the connection element is in the first orientation, the stellar protrusion of the connection portion passes through the stellar extending portion of the opening and is separated from the port.
